(19) United States
(12) Patent Application Publication
(10) Pub. No.: US 2026/0072366 A1
(43) Pub. Date: Mar. 12, 2026

(54) MAGNETIC ONE-COMPONENT TONER

(71) Applicant: KYOCERA Document Solutions Inc., Osaka (JP)

(72) Inventor: Sho SUMIOKA, Osaka (JP)

(73) Assignee: KYOCERA Document Solutions Inc., Osaka (JP)

(21) Appl. No.: 19/316,502

(22) Filed: Sep. 2, 2025

(30) Foreign Application Priority Data
Sep. 9, 2024 (JP) 2024-155135

(51) Int. Cl. G03G 9/083

(52) U.S. Cl. CPC G03G 9/0834; G03G 9/0836

(57) ABSTRACT

Magnetic one-component toner has toner particles including: a toner base particle containing at least a binder resin and a magnetic powder, and an external additive attached to its surface. The toner base particle includes as a ferroelectric material a metal titanate and the dielectric constant of the toner base particle is 8.0 [F/m] or more but 12.0 [F/m] or less.

### INCORPORATION BY REFERENCE

This application is based on and claims the benefit of priority from Japanese Patent Application No. 2024-155135 filed on Sep. 9, 2024, the contents of which are hereby incorporated by reference.

### BACKGROUND

The present disclosure relates to magnetic one-component toner.

Generally, in an electrophotographic method, the surface of an electrostatic latent image carrying member is electrostatically charged by corona discharge or the like and then it is exposed to laser light or the like to form an electrostatic latent image. The formed electrostatic latent image is developed with toner to form a toner image. The formed toner image is transferred to a recording medium to produce a high-quality image.

As methods for developing an electrostatic latent image with toner, there are known a magnetic one-component development method using only magnetic toner and a two-component development method using two-component developer containing non-magnetic toner and magnetic carrier. Magnetic toner is less expensive than two-component developer, so it is widely used in monochrome printers.

In the magnetic one-component development method, a magnetic force holds a toner layer in a gap between a development sleeve and a restriction blade, and the toner is electrostatically charged by friction between the surface of the development sleeve and the toner. Thus, large mechanical stress acts on the toner and, during durability printing, an external additive may sink or come off, resulting in image defects such as low image density and image fogging.

### SUMMARY

According to one aspect of the present disclosure, magnetic one-component toner has toner particles including: a toner base particle containing at least a binder resin and a magnetic powder; and an external additive attached to its surface. The toner base particle includes as a ferroelectric material a metal titanate, and the dielectric constant of the toner base particle is 8.0 [F/m] or more but 12.0 [F/m] or less.

### DETAILED DESCRIPTION

Now, an embodiment of the present disclosure will be described in detail. Unless otherwise defined, a result of evaluation with respect to a powdery substance (specifically, toner core particle, toner base particle, external additive, toner, and the like) is given as a number average of values obtained by measuring respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (LA-750; manufactured by HORIBA, Ltd.). Unless otherwise defined, a measured value of an acid number or a hydroxyl number is a value obtained by measuring in accordance with “JIS (Japanese Industrial Standards) K0070-1992.” Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in that polymer is derived from any of that compound and their derivatives. The term “(meth)acryl” is occasionally used to refer to “acrylic” and “methacrylic” collectively. The term “(meth)acryloyl” is occasionally used to refer to “acryloyl (CH₂═CH—CO—)” and “methacryloyl (CH₂═C(CH₃)—CO—)” collectively.

Toner according to the embodiment can be suitably used as positively chargeable toner for development of electrostatic latent images. The toner according to the embodiment is a powdery substance containing a plurality of toner particles (particles each configured as described later). The toner contains a magnetic powder and is used as one-component developer.

A toner particle in the toner according to the embodiment has a toner base particle and an external additive attached to the surface of the toner base particle. That is, a toner particle before the external additive attaches to it is referred to as “toner base particle.” If the toner base particle has a shell layer, the particle before the shell layer is formed is referred to as “toner core particle.” If the toner base particle has no shell layer, the toner base particle is referred to also as “toner core particle.”

The toner according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with magnetic one-component toner. In the development process, toner (e.g., toner electrostatically charged by friction with a blade) on a development sleeve (e.g., a superficial part of a development roller in the developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. In this way, an image is formed on the recording medium.

### [1. Basic Configuration of Toner]

Magnetic one-component toner (hereinafter, referred to simply as toner) according to the present disclosure has a toner base particle and an external additive attached to the surface of the toner base particle. The toner base particle at least contains a binder resin, a magnetic powder, and a ferroelectric material. As necessary, the toner base particle may contain, in the binder resin, a colorant, a charge control agent, and the like.

The toner according to the present disclosure contains a ferroelectric material inside the toner base particle. The dielectric constant of the toner base particle is adjusted by the ferroelectric material to 8.0 [F/m] or more but 12.0 [F/m] or less.

### [2. Materials for Toner]

A description will be given below, one by one, of the binder resin, the magnetic powder, the ferroelectric material, the release agent, the colorant, and the charge control agent that form the toner base particle, the external additive that is externally added to the toner base particle, and a method of producing the toner according to the present disclosure.

### (Binder Resin)

In the toner according to the present disclosure, the toner base particle contains a binder resin. The binder resin that can be contained in the toner base particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties on sheets, those containing at least one of polyester resin and styrene-acrylic-based resin is preferred, and polyester resin is more preferred. The polyester resin will be described below.

Usable as polyester resin are those obtained by condensation polymerization or condensation copolymerization of a dihydric or a trihydric or higher alcohol component and a divalent or a trivalent or higher carboxylic acid component. Examples of components used to synthesize polyester resin include alcohol components and carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexantricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of its mass average molecular weight (Mw) to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties and durability of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tend to be poor. If the glass transition point is too low, the heat-resistant preservation properties of the toner tend to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.) as a measuring instrument. 10 mg of a measurement sample is put in an aluminum pan while an empty aluminum pan is used as a reference. From the endothermic curve plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Magnetic Powder)

The toner base particle contains a magnetic powder in the binder resin. Suitably usable as a material of the magnetic powder is, for example, a ferromagnetic metal (more specifically, iron, cobalt, nickel, an alloy of one or more of these metals, or the like), a ferromagnetic metal oxide (more specifically, ferrite, magnetite, chromium dioxide, or the like), or a material subjected to ferromagnetization treatment (more specifically, a carbon material made ferromagnetic by heat treatment, or the like). For the purpose of suppressing the elution of a metal ion (e.g., iron ion) from the magnetic powder, preferably, surface-treated magnetic particles are used as the magnetic powder. One type of magnetic powder can be used singly or a plurality of types of magnetic powder can be used in combination.

The particle size of the magnetic powder is not particularly limited within the scope consistent with the object of the present disclosure. Specifically, the particle size of the magnetic powder is preferably 0.1 μm or more but 1.0 μm or less, and more preferably 0.1 μm or more but 0.5 μm or less. Using a magnetic powder with such a particle size makes it easy to uniformly disperse the magnetic powder in the binder resin.

For the purpose of improving the dispersion properties of the magnetic powder in the binder resin, it is possible to use a magnetic powder that is surface-treated with a surface treatment agent such as a titanium-based coupling agent or a silane-based coupling agent.

The amount of magnetic powder used is not particularly limited within the scope consistent with the object of the present disclosure. Specifically, the amount of magnetic powder used is, relative to the total mass of the toner, preferably 30 mass % or more but 60 mass % or less, and more preferably 40 mass % or more but 60 mass % or less. Using too large an amount of magnetic powder can result in difficulty forming images of the desired image density over a long period or extremely poor fixing properties of the toner on sheets; using too small an amount of magnetic powder can result in the formed image being prone to be fogging or difficulty forming images of the desired image density over a long period.

### (Ferroelectric Material)

The toner base particle contains a ferroelectric material in the binder resin. As the ferroelectric material, a metal titanate is used. Examples of metal titanates include strontium titanate, magnesium titanate, calcium titanate, and barium titanate. Two or more of ferroelectric materials can be used in combination.

The dielectric constant of the toner base particle can be adjusted by the amount of ferroelectric material added. In the toner according to the present disclosure, the dielectric constant of the toner base particle is adjusted to 8.0 [F/m] or more but 12.0 [F/m] or less. If the dielectric constant of the toner base particle is less than 8.0 [F/m], it has so high charging properties as to cause fogging in the formed image. It then also has unstable charging properties, leading to low image density after durability printing. By contrast, if the dielectric constant of the toner base particle is greater than 12.0 [F/m], it has so low charging properties as to cause a drop in image density.

### (Release Agent)

For the purpose of improving its fixing properties and offset resistance, the toner base particle can contain a release agent. The type of release agent that can be added in the toner base particle is not particularly limited. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such release agents to the toner base particle helps more efficiently suppress offsetting and image smearing (stain around an image caused by its being rubbed).

When a polyester resin is used as the binder resin, from the viewpoint of compatibility, as the release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as the release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax Cl (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner base particle, preferably 1 mass % or more but 10 mass % or less. Using too small an amount of release agent can result in less-than-expected suppression of offsetting or image smearing in image formation; using too large an amount of release agent can result in fusing-together of toner and hence poor heat-resistant preservation properties of the toner.

### (Colorant)

The toner base particle is usually black because it contains a magnetic powder as an essential component. Thus, the toner can contain, within the scope consistent with the object of the present disclosure, any known pigment or dye as a colorant for the purpose of adjusting the image formed with the toner according to the present disclosure to a more preferable black hue. Specific examples of pigments include carbon black and specific examples of dyes include acid violet.

The amount of colorant used is not particularly limited within the scope consistent with the object of present disclosure. Specifically, the amount of colorant used is, relative to the total mass of the toner base particle, preferably 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner base particle can contain a charge control agent for the purposes of improving the charge level of the toner and the charge response properties as the index of whether it can be charged to a predetermined charge level in a short time, and thereby obtaining toner with excellent durability and stability. Since the toner according to the present disclosure is positively chargeable toner, a positively chargeable charge control agent is used.

The type of charge control agent that can be contained in the toner base particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. More specific examples include: styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of charge amount within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner base particle, preferably 0.1 mass % or more but 10 mass % or less. Using too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Using too large an amount of charge control agent can lead to poorer resistance to environment and this tends to cause image faults in the formed image due to insufficient charging under high temperature and high humidity, contamination of a latent image carrying member with toner components, and the like.

The toner base particle can be a toner base particle having no shell layer (non-capsule toner base particle) or a toner base particle having a shell layer (capsule toner base particle). Forming a shell layer on the surface of a non-capsule toner base particle (toner core particle) yields a capsule toner base particle. The shell layer can be composed substantially solely of a thermosetting resin, substantially solely of thermoplastic resin, of both a thermoplastic and a thermosetting resin.

### (External Additive)

In the toner according to the present disclosure, the surface of the toner base particle is treated with an external additive. The type of external additive is not particularly limited within the scope consistent with the object of the present disclosure and thus any external additive known to be used in toner can be appropriately selected. Specific examples of suitable external additives include silica, metal oxides such as alumina, titanium oxide, magnesium oxide, zinc oxide, strontium titanate, and barium titanate, and resin particles. Two or more types of such external additives can be used in combination.

The particle size of the external additive is not particularly limited within the scope consistent with the object of the present disclosure; typically, it is preferably 0.01 μm or more but 1.0 μm or less.

The amount of external additive used is not particularly limited within the scope consistent with the object of the present disclosure. Typically, the amount of external additive used is, relative to the total mass of the toner base particle produced by forming the shell layer on the surface of the toner core particle, preferably 0.1 mass % or more but 10 mass % or less, and more preferably 0.2 mass % or more but 5 mass % or less. Using too small an amount of external additive can lead to poor hydrophobicity of the toner. As a result, the toner is more susceptible to the influence of water molecules in air in a high-temperature high-humidity environment, leading to problems such as low image density of the formed image due to extremely low charge amount of the toner and low fluidity of the toner. Using too large an amount of external additive can result in low image density due to excessive charging of the toner.

### [Production Method for Toner]

Next, a production method for the toner according to the present disclosure will be described. The production method for the toner includes a production method for the toner base particle and a method for external addition treatment to attach the external additive to the surface of the toner base particle. The production method for the toner base particle is not particularly limited so long as it can form the toner base particle with a predetermined structure. As necessary, a toner base particle coated with a shell layer can be used. As a suitable production method for the positively chargeable toner described above, a method for producing the toner base particle and a method for external addition treatment will be described one by one below.

### (Method for Producing the Toner Base Particle)

The method for producing the toner base particle is not particularly limited so long as it can satisfactorily disperse a magnetic powder and any optional components such as a colorant, a release agent, and a charge control agent in the binder resin. Examples of suitable methods for producing the toner base particle include a pulverization method and an agglomeration method.

In the pulverization method, the binder resin and any components such as a magnetic powder, a colorant, a release agent, and a charge control agent are mixed using a mixer or the like; then the binder resin and the components blended in the binder resin are melted and kneaded using a kneader such as a uniaxial or biaxial extruder; and the cooled kneaded product is pulverized and classified. While the average particle size of the toner base particle is not particularly limited within the scope consistent with the object of the present disclosure, generally it is preferably 5 μm or more but 10 μm or less.

In the agglomeration method, in an aqueous solvent containing fine particles of each of the binder resin, a magnetic powder, a colorant, a release agent, and a charge control agent, these fine particles are agglomerated until they have a predetermined particle size. This forms an agglomerate particle containing the binder resin, the release agent, the charge control agent, and the colorant. Subsequently, the obtained agglomerate particle is heated so that the components in the agglomerate particle coalesce. This yields a toner base particle with a predetermined particle size.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that the particles of the external additive do not sink in the toner base particle.

The toner according to the present disclosure described above, in cases where images are formed for a long period in various environments including a high-temperature high-humidity environment and a low-temperature low-humidity environment, helps stabilize the charge amount of the toner. Thus, the images can be formed with the desired density. It is also possible to effectively suppress fogging in the formed image after durability printing. Accordingly, the toner according to the present disclosure can be suitably used in a variety of image forming apparatuses. Now, the effects of the present disclosure will be described more specifically by way of examples. The present disclosure is not limited in any way by those examples.

### EXAMPLES

### Production Example 1

### (Production of Strontium Titanate)

A jacketed reaction vessel of stainless steel with a volume of 2 L provided with a stirrer, two dropping nozzles, a thermometer, and a circulation pump was loaded with a hydrous titanium oxide slurry that has been desulfurized and deflocculated. The loaded hydrous titanium oxide slurry contained 0.626 mol of titanium oxide (TiO₂). Next, to the reaction vessel, an aqueous solution of strontium chloride was added in an amount such that the molar ratio (SrO/TiO₂) of strontium oxide (SrO) to titanium oxide in the reaction vessel was 1.15.

Next, ion-exchange water was added to the reaction vessel to adjust the titanium dioxide concentration in the reaction vessel to 0.626 mol/L. Then, the reaction vessel was left to stand for 20 minutes while nitrogen gas was blown into it, so that substitution with nitrogen gas was carried out inside the reaction vessel. Next, with nitrogen gas flowing in the reaction vessel, while a solution containing metatitanic acid and strontium chloride was stirred and mixed at a rotation rate of 300 rpm, its temperature was raised to 90° C. under the condition of 13.5° C./min.

Then, while the mixture solution was kept at 90° C. and was stirred and mixed at a rotation rate of 300 rpm, 143 mL of a 2.5N aqueous solution of sodium hydroxide was added over twelve hours. Next, in a nitrogen atmosphere at 90° C., the contents were stirred to react at a rotation rate of 300 rpm for one hour.

After the reaction, the temperature inside the reaction vessel was lowered to 40° C. Then, in a nitrogen atmosphere, the supernatant of the contents of the reaction vessel was removed. Subsequently, in a nitrogen atmosphere, an operation of adding 2.5 L of pure water to the reaction vessel and then removing the supernatant by decantation was performed twice to wash the contents.

Next, the contents of the reaction vessel were filtered using a Buchner funnel and the obtained solid substance in the form of a cake was dried for eight hours in the atmosphere at 110° C. This yielded strontium titanate particles with a volume-average primary particle size of 100 nm and a relative permittivity of 135.3.

### Production Example 2

### (Production of Magnesium Titanate)

### (2-1. Reaction Preparation Process)

After deferrization of metatitanic acid obtained by a sulfuric acid process, an aqueous solution of sodium hydroxide was added to the deferrized metatitanic acid to prepare a suspension liquid with a pH value of 9.0. After the obtained suspension liquid was desulfurized, hydrochloric acid was added to the desulfurized suspension liquid to adjust the pH value of the suspension liquid to 5.8. The suspension liquid having its pH value adjusted to 5.8 was then filtered (solid-liquid separation), the obtained solid part was washed with water, and ion-exchange water was added to the washed solid part to obtain a slurry with a Ti concentration of 2.13 mol/L. Hydrochloric acid was added to the obtained slurry to deflocculate it. The pH value of the deflocculated slurry was 1.4.

Next, the deflocculated slurry (equivalent to 1.8770 mol of TiO₂) was put in a 3 L reaction vessel. Then, an aqueous solution of magnesium chloride (MgCl₂) equivalent to 2.1590 mol of Mg was added to the reaction vessel. The contents of the reaction vessel after the addition of the aqueous solution of magnesium chloride (hereinafter referred to simply as the vessel contents) had a molar ratio of Mg to Ti (Mg/Ti) of 1.15.

Next, an aqueous solution of lanthanum chloride (LaCl₃) equivalent to 0.2160 mol of La was added to the reaction vessel. The vessel contents after the addition of the aqueous solution of lanthanum chloride had a molar ratio of La to Mg (La/Mg) of 0.10. Then, niobium pentoxide (Nb₂O₅) equivalent to 0.0188 mol of Nb was added to the reaction vessel. The vessel contents after the addition of the niobium pentoxide had a molar ratio of Nb to Ti (Nb/Ti) of 0.01. Subsequently, ion-exchange water was added to the vessel contents to obtain a slurry with a Ti concentration of 0.939 mol/L.

### (2-2. Reaction Process)

While the slurry (Ti concentration: 0.939 mol/L) obtained in the reaction preparation process was stirred, the temperature inside the reaction vessel was raised to 90° C. After that, 553 mL of an aqueous solution of sodium hydroxide (NaOH concentration: 10 mol/L) was added to the reaction vessel at a constant rate over one hour. Next, after the temperature inside the reaction vessel was raised to 95° C. and, while the temperature inside the reaction vessel was kept at 95° C., the vessel contents were stirred for one hour. Then, the vessel contents were cooled until their temperature fell to 50° C., and then hydrochloric acid was added to the cooled vessel contents to adjust the pH value of the vessel contents to 5.0. Subsequently, while the temperature inside the reaction vessel was kept at 50° C., the vessel contents were stirred for one hour to obtain a precipitate. The obtained precipitate was washed by decantation and filtered (solid-liquid separation), and then the obtained solid part was dried for ten hours in an atmosphere at a temperature of 120° to obtain a powder of magnesium titanate particles containing lanthanum and niobium.

### (2-3. Hydrophobization Treatment Process)

To a three-necked flask provided with a thermometer and a stirring device, 100 mass parts of the magnesium titanate particles obtained in the reaction process were added and the air inside the flask was replaced with nitrogen to create a nitrogen atmosphere in the flask. Then, while the flask contents were stirred, 15 mass parts of isobutyl trimethoxy silane and an amount of distilled water adequate to promote the reaction (specifically, hydrolysis reaction) on the surface of magnesium titanate particles were sprayed into the flask. After that, while the flask contents were stirred, the magnesium titanate particles were reacted with isobutyl trimethoxy silane for two hours under the condition of a temperature of 110° C. As a result, isobutyl groups (specifically, isobutyl groups derived from isobutyl trimethoxy silane) were introduced to the surface of magnesium titanate particles to yield a powder of hydrophobized magnesium titanate particles.

### Production Example 3

### (Production of Calcium Titanate)

### (3-1. Reaction Preparation Process)

After deferrization of metatitanic acid obtained by a sulfuric acid process, an aqueous solution of sodium hydroxide was added to the deferrized metatitanic acid to prepare a suspension liquid with a pH value of 9.0. After the obtained suspension liquid was desulfurized, hydrochloric acid was added to the desulfurized suspension liquid to adjust the pH value of the suspension liquid to 5.8. The suspension liquid having its pH value adjusted to 5.8 was then filtered (solid-liquid separation), the obtained solid part was washed with water, and ion-exchange water was added to the washed solid part to obtain a slurry with a Ti concentration of 2.13 mol/L. Hydrochloric acid was added to the obtained slurry to deflocculate it. The pH value of the deflocculated slurry was 1.4.

Next, the deflocculated slurry (equivalent to 1.8770 mol of TiO₂) was put in a 3 L reaction vessel. Then, an aqueous solution of calcium chloride (CaCl₂)) equivalent to 2.1590 mol of Ca was added to the reaction vessel. The vessel contents after the addition of the aqueous solution of calcium chloride had a molar ratio of Ca to Ti (Ca/Ti) of 1.15.

Next, an aqueous solution of lanthanum chloride (LaCl₃) equivalent to 0.2160 mol of La was added to the reaction vessel. The vessel contents after the addition of the aqueous solution of lanthanum chloride had a molar ratio of La to Ca (La/Mg) of 0.10. Then, niobium pentoxide (Nb₂O₅) equivalent to 0.0188 mol of Nb was added to the reaction vessel. The vessel contents after the addition of the niobium pentoxide had a molar ratio of Nb to Ti (Nb/Ti) of 0.01. Subsequently, ion-exchange water was added to the vessel contents to obtain a slurry with a Ti concentration of 0.939 mol/L.

### (3-2. Reaction Process)

While the slurry (Ti concentration: 0.939 mol/L) obtained in the reaction preparation process was stirred, the temperature inside the reaction vessel was raised to 90° C. After that, 553 mL of an aqueous solution of sodium hydroxide (NaOH concentration: 10 mol/L) was added to the reaction vessel at a constant rate over one hour. Next, after the temperature inside the reaction vessel was raised to 95° C. and, while the temperature inside the reaction vessel was kept at 95° C., the vessel contents were stirred for one hour. Then, the vessel contents were cooled until their temperature fell to 50° C., and then hydrochloric acid was added to the cooled vessel contents to adjust the pH value of the vessel contents to 5.0. Subsequently, while the temperature inside the reaction vessel was kept at 50° C., the vessel contents were stirred for one hour to obtain a precipitate. The obtained precipitate was washed by decantation and filtered (solid-liquid separation), and then the obtained solid part was dried for ten hours in an atmosphere at a temperature of 120° C. to obtain a powder of calcium titanate particles containing lanthanum and niobium.

### (3-3. Hydrophobization Treatment Process)

To a three-necked flask provided with a thermometer and a stirring device, 100 mass parts of the calcium titanate particles obtained in the reaction process were added and the air inside the flask was replaced with nitrogen to create a nitrogen atmosphere in the flask. Then, while the flask contents were stirred, 15 mass parts of isobutyl trimethoxy silane and an amount of distilled water adequate to promote the reaction (specifically, hydrolysis reaction) on the surface of calcium titanate particles were sprayed into the flask. After that, while the flask contents were stirred, the calcium titanate particles were reacted with isobutyl trimethoxy silane for two hours under the condition of a temperature of 110° C. As a result, isobutyl groups (specifically, isobutyl groups derived from isobutyl trimethoxy silane) were introduced to the surface of calcium titanate particles to yield a powder of hydrophobized treated calcium titanate particles.

### Production Example 4

### (Production of Toner Base Particles)

The following were mixed for five minutes at a rotation rate of 2000 rpm using an FM mixer (FM-20B, manufactured by NIPPON COKE & ENGINEERING CO., LTD.) to obtain a mixture: as a binder resin, 100 mass parts of polyester resin (HP-313, manufactured by The Nippon Synthetic Chemical Industry Co., Ltd.); 80 mass parts of a magnetic powder (TN-15, manufactured by MITSUI MINING & SMELTING CO., LTD.); 4 mass parts of a charge control agent (FCA-201-PS, manufactured by Fujikura Kasei Co., Ltd.); 4 mass parts of a release agent (carnauba wax, manufactured by TOA KASEI CO., LTD.); and as a ferroelectric material, 14 mass parts of the strontium titanate particles obtained in Production Example 1.

The obtained mixture was melted and kneaded using a biaxial extruder (TEM-26SS, manufactured by Toshiba Machine Co., Ltd.) to obtain a kneaded product. The melting and kneading was carried out under the conditions of a cylinder temperature of 120° C., an axial rotation rate of 100 rpm, and a processing rate of 90 g/min. The kneaded product was cooled and was then coarsely pulverized using a pulverizer (Model Roteplex 16/8, manufactured by HOSOKAWA MICRON CORPORATION). The obtained coarsely pulverized product was pulverized using a mechanical pulverizer (Turbomill, manufactured by FREUND-TURBO CORPORATION) to obtain a pulverized product. The pulverized product was then classified using a wind classifier (Model EJ-L-3 (LABo), manufactured by Nittetsu Mining Co., Ltd.) to obtain toner base particles A with an average primary particle size of 7.0 μm.

With the amount of magnetic powder added changed to 50 mass parts and the amount of strontium titanate particles added changed to predetermined amounts, through an otherwise similar procedure to toner base particles A, toner base particles B, C, E, and F were obtained.

With the amount of magnetic powder added changed to 50 mass parts, the amount of strontium titanate particles added changed to 10 mass parts, and 1.0 mass parts of barium titanate (HPBT, manufactured by Fuji Titanium Industry Co., Ltd.) added, through an otherwise similar procedure to toner base particles A, toner base particles D were obtained.

### (Measurement of Dielectric Constant of Toner Base Particles)

1 g of toner base particles were compressed for two minutes under the condition of a pressure of 200 kg/cm² to be formed into a disk-shaped pellet (measurement sample) 25 mm in diameter and 1 mm thick. Next, the measurement sample was set on a rotational rheometer (ARES-G2, manufactured by TA Instruments) fitted with a 25 mm diameter dielectric constant measurement jig (electrode). Using an LCR meter (4284A Precision LCR Meter, manufactured by Keysight Technologies), under the conditions of a measurement temperature of 25° C., a load of 150 g, an applied voltage of 1.0 V, and a frequency of 1.0 MHz, the dielectric constant of the toner base particles was measured.

### Production Example 5

### (Production of Toner)

To toner base particles A to F obtained in Production Example 4, 1 mass % of silica particles (RA200H, manufactured by NIPPON AEROSIL CO., LTD.) were added and theses were mixed for 15 minutes using a Henschel mixer (manufactured by MITSUI MIIKE MACHINERY CO., LTD.) to attach (externally add) the silica particles to the toner base particles. After that, the product was sieved through a 100 mesh sieve (with a mesh of 150 μm) to obtain toners of Present Disclosure 1 to 4 and Comparative Examples 1 to 2.

The type and amount of ferroelectric material added, the amount of magnetic powder added, and the dielectric constant of toner base particles contained in the toners of Present Disclosure 1 to 4 and Comparative Examples 1 to 2 are shown in Table 1.

TABLE 1

| | | | | | Dielectric |
|---|---|---|---|---|---|
| | | Amount of | Ferroelectric | | Constant of |
| | Toner | Magnetic | Material | | Toner Base |
| | Base | Powder | | Amount | Material |
| Toner | Particle | Added* | Compound | Added* | [F/m] |
| Present | A | 80 | Strontium | 14.0 | 8.0 |
| Disclosure 1 | | | Titanate | | |
| Present | B | 50 | Strontium | 12.8 | 8.0 |
| Disclosure 2 | | | Titanate | | |
| Present | C | 50 | Strontium | 30.0 | 12.0 |
| Disclosure 3 | | | Titanate | | |
| Present | D | 50 | Strontium | 10.0 | 9.1 |
| Disclosure 4 | | | Titanate | | |
| | | | Barium | 1.0 | |
| | | | Titanate | | |
| Comparative | E | 50 | Strontium | 12.5 | 7.9 |
| Example 1 | | | Titanate | | |
| Comparative | F | 50 | Strontium | 30.5 | 12.1 |
| Example 2 | | | Titanate | | |

### [Evaluation of Image Density and Image Fogging]

With each of the toners of Present Disclosure 1 to 4 and Comparative Examples 1 to 2, the image density and the image fogging observed when it was used were evaluated by the methods described below.

### (Image Density)

Each of the toners of Present Disclosure 1 to 4 and Comparative Examples 1 to 2 obtained in Production Example 5 was installed in a development portion in an evaluation machine (monochrome printer ECOSYS LS-4200DN, manufactured by KYOCERA Document Solutions Inc.). After the toner was installed, in a normal-temperature normal-humidity environment (temperature: 23° C., humidity: 50% RH), a test image with a coverage ratio of 5% was printed on 100,000 sheets. The image density (ID) was measured immediately after the start of printing (at the outset) and after printing 100,000 sheets (after durability printing) using a reflection densitometer (RD914, manufactured by Gretag-Macbeth). The evaluation criteria for image density were as follows:
GOOD: ID≥1.3
FAIR: 1.2≤ID<1.3
POOR: ID<1.2

### (Image Fogging)

The fog density (FD) in the blank background around the image on the printed result was measured immediately after the start of printing (at the outset) and after printing 100,000 sheets (after durability printing) using a reflection densitometer (RD914, manufactured by Gretag-Macbeth). The fog density (FD) was calculated using the following formula (1).

FD=(Reflection density of the blank part of the printed sheet)−(Reflection density of the unprinted sheet)

The evaluation criteria for image fogging were as follows:
GOOD: FD<0.003
FAIR: 0.003≤FD≤0.007
POOR: FD>0.007

Table 2 shows the results of evaluation of the image density and the image fogging observed with each of the toners of Present Disclosure 1 to 4 and Comparative Examples 1 to 2.

TABLE 2

| | Image Density [ID] | | | Image Fogging [FD] | | |
|---|---|---|---|---|---|---|
| | | After | Conclu- | | After | Conclu- |
| Toner | Initial | Durability | sion | Initial | Durability | sion |
| Present | 1.35 | 1.34 | GOOD | 0.000 | 0.002 | GOOD |
| Disclosure 1 | | | | | | |
| Present | 1.35 | 1.36 | GOOD | 0.001 | 0.002 | GOOD |
| Disclosure 2 | | | | | | |
| Present | 1.34 | 1.34 | GOOD | 0.000 | 0.001 | GOOD |
| Disclosure 3 | | | | | | |
| Present | 1.33 | 1.34 | GOOD | 0.001 | 0.002 | GOOD |
| Disclosure 4 | | | | | | |
| Comparative | 1.35 | 1.29 | FAIR | 0.001 | 0.003 | FAIR |
| Example 1 | | | | | | |
| Comparative | 1.31 | 1.22 | FAIR | 0.001 | 0.001 | GOOD |
| Example 2 | | | | | | |

Table 2 clearly shows the following the toners of Present Disclosure 1 to 4, in which the dielectric constant of the toner base particles was 8.0 [F/m] or more but 12.0 [F/m] or less by the use of the ferroelectric material, all showed a satisfactory image density (ID) of 1.3 or higher at the outset and after printing 100,000 sheets. Also the fog density (FD) was less than 0.003 after printing 100,000 sheets and no image fogging was observed.

In contrast, the toner of Comparative Example 1, in which the dielectric constant of the toner base particles was 7.9 [F/m], exhibited an image density (ID) of 1.29 after printing 100,000 sheets and low image density was observed. Also the fog density (FD) was 0.003 after printing 100,000 sheets and image fogging was observed.

On the other hand, the toner of Comparative Example 2, in which the dielectric constant of the toner base particles was 12.1 [F/m], showed an image density (ID) of 1.22 after printing 100,000 sheets and satisfactory image density was not obtained. The toner of Comparative Example 2 showed a fog density (FD) of 0.001 after printing 100,000 sheets and no image fogging was observed. The reason is considered to be as follows: the volume resistivity of the strontium titanate was lower than those of the other materials (such as the binder resin), so an excess amount of strontium titanate added increased the area over which it is exposed on the surface of the toner base particles and resulted in a low surface resistance of the toner was, or the low chargeability of strontium titanate itself; these factors, among others, affected to result in a low charge amount of the toner and hence a low fog density.

The results described above indicate that, with the dielectric constant of the toner base particles set to 8.0 [F/m] or more but 12.0 [F/m] or less by use of a ferroelectric material, the magnetic one-component toner can maintain image density after durability printing while also preventing image fogging.

The present disclosure finds application in positively chargeable magnetic one-component toner for use in an electrophotographic method. Based on the present disclosure, it is possible, by stabilizing the charging properties of the toner over a long period, to provide magnetic one-component toner that can prevent low image density and image fogging.

What is claimed is:

1. Magnetic one-component toner composed of toner particles, the toner particles each comprising:
a toner base particle that contains at least a binder resin and a magnetic powder; and
an external additive attached to a surface of the toner base particle,
wherein
the toner base particle includes as a ferroelectric material a metal titanate, and
a dielectric constant of the toner base particle is 8.0 [F/m] or more but 12.0 [F/m] or less.

2. The magnetic one-component toner according to claim 1, wherein
the metal titanate is one, or two or more, selected from a group of strontium titanate, magnesium titanate, calcium titanate, and barium titanate.

3. The magnetic one-component toner according to claim 1, wherein
the external additive is silica particles.
